(19) United States
(12) Patent Application Publication
(10) Pub. No.: US 2020/0218220 A1
(43) Pub. Date: Jul. 9, 2020

(54) METHOD AND DATA PROCESSING DEVICE FOR THE COMPUTER-SUPPORTED PROVIDING OF INFORMATION, AVAILABLE IN THE FORM OF COMPUTER CODE, FOR A PROCESS MODULE, AND COMPUTER PROGRAM PRODUCT FOR CARRYING OUT THE METHOD

(71) Applicant: ABB Schweiz AG, Baden (CH)

(72) Inventors: Katharina Stark, Weinheim (DE); Mario Hoernicke, Landau (DE)

(21) Appl. No.: 16/823,906

(22) Filed: Mar. 19, 2020

Related U.S. Application Data
(63) Continuation of application No. PCT/EP2018/074492, filed on Sep. 11, 2018.

(30) Foreign Application Priority Data
Sep. 19, 2017 (EP) 17191780.0

(51) Int. Cl. G05B 19/05; G05B 15/02

(52) U.S. Cl. CPC G05B 19/056; G05B 15/02; G05B 19/052

(57) ABSTRACT

The invention relates to a method for the computer-supported providing of information, available in the form of computer code, for a service of a process module, which can be coupled for forming an automated process section with other process modules, comprising the following steps: providing an operator with a selection option for statuses of the service of the process module from a predefined status diagram with at least two statuses; receiving an input for establishing at least one status from the predefined status diagram for the service; providing a list of those units of the process module which emit first signals and/or receive second signals; for each status of the service, enabling and receiving corresponding inputs for providing first data, which specifies an assignment of possible first and second signals of units from the list as a cause to possible first and second signals of units from the list as an effect; and, based on the first data, determining second data which specifies an assignment of possible first and second signals of the units as a cause in an initial status of the service to possible first and second signals of the units from the list in an end status of the service. The invention also relates to a corresponding data processing device and a computer program product.

The invention relates to a method and data processing apparatus for the computer-aided provision of information, available in the form of computer code, pertaining to a service of a process module that is couplable to other process modules and is thus usable in an automated process section for implementing a technical process, in particular a chemical or pharmaceutical process, by performing a service. The invention also relates to a corresponding computer program product.

The modularization of process-engineering installations is perceived, particularly in the chemicals and pharmaceuticals industry, as an outstanding opportunity to construct and use process sections efficiently in terms of timing and at low cost and also to be able to modify them again. This can also be used, in particular, to produce chemical and pharmaceutical products in rather smaller quantities in precisely matched technical processes.

Services are individual functions of the process module in the process, such as for example regulating temperature, metering, stirring, etc. As a rule, a process module can perform multiple services. The process modules are supposed to be actuated in object-oriented and state-based fashion by calling the services.

A single process module comprises a multiplicity of components that are together responsible for performing the individual services, and each process module also has a separate control unit for these components. A superordinate process control unit (on what is known as the process management level) is supposed to have a representation of the process module or ideally of the currently performed service, it communicates with the process module and actuates the control unit of the process module externally in order to retrieve the services and set the individual steps or states thereof. This requires the superordinate process control unit to have information pertaining to the service and the process module that contains the aforementioned representation, indicates how the communication with the process module needs to take place and how a service needs to be performed by control. Such information is referred to as “module type package”, MTP, in the field of the art. In industry in Germany, there are efforts to standardize the interfaces between process management level and process modules, in particular as far as the representation in codes such as the MTP is concerned. VDE guideline 2658 is a first step in the direction of standardization in this regard.

Generating information such as the MTP is sophisticated, since firstly it is based on prior information about the module (for the most part from the manufacturer of the module), and, secondly, interconnection of modules from different manufacturers in a process section requires a format that is usable across manufacturers. Previous solutions have been put into effect by and with the manufacturers of modules. However, this does not always allow optimum use of the many different options of the process modules, as far as the configuration of services is concerned. It would be desirable if services of process modules could be defined more easily.

It is an object of the present invention to facilitate the development and setting of services, ideally for any process modules.

The object is achieved by the method having the features of claim 1, by the method having the features of claim 9, by the computer program product of claim 10 and a data processing apparatus having the features of claim 11. Advantageous refinements are specified in the subclaims.

The method according to the invention for the computer-aided provision of information, available in the form of computer code, pertaining to a service of a process module that is couplable to other process modules and is thus usable in an automated process section for implementing a technical, in particular chemical or pharmaceutical, process by performing a service therefore comprises the steps of:
providing a selection option for states of the service of the process module from a prescribed state diagram having at least two states to an operator,
receiving an input from the operator for defining at least one state from the prescribed state diagram that the service is supposed to be able to adopt for the process module,
providing a list of units (or components) of the process module that deliver first signals and/or receive second signals,
for each state that the service can adopt for the process module, allowing and receiving inputs for providing first data, the latter indicating an association between possible first and second signals of the units from the list for a plurality of the units and in particular for all units as cause and possible first and second signals of the units from the list for a plurality of the units and in particular for all units as effect,
using the first data to determine second data, the latter indicating an association between possible first and second signals of the units from the list for a plurality of the units and in particular for all units as cause in an initial state of the service of the process module from all states that the service is supposed to be able to adopt and possible first and second signals of the units from the list for a plurality of the units and in particular for all units as effect in a final state of the service from all states that the process module is supposed to be able to adopt.

As a result of the method taking up a prescribed state diagram and the states of the service to be defined needing to be selected from the states that the prescribed state diagram contains, the definition of the services in itself caters for standardization. This facilitates prescribing services independently of the manufacturer of the process module. The units or components on the list typically are or comprise sensors and actuators of the process module. The associations in the individual states according to the first data therefore indicate (logical, but in particular physical and possibly chemical) cause-effect relationships that are supposed to be valid for the states of the service. The associations according to the second data therefore indicate the (logical, but in particular physical and possibly chemical) cause-effect relationship of the service as a whole. In one specific aspect, which is not pursued in more detail in this instance, the method does not even require the last step.

In one preferred embodiment of the method, some of the states from the prescribed state diagram are an absolute prerequisite for each process module and the selection option relates only to at least one further state or at least one state group. The reason is that in some state diagrams, the states are defined such that some of them exist in any service, e.g. an initial state, a state of “running” operation and a final state. If no state is an absolute prerequisite, the method can be designed such that at least two states, possibly at least three states, or a higher minimum number, can be defined by the operator.

For the purposes of the chemicals and pharmaceuticals industry, in particular, it is advantageous if the state diagram corresponds to the state model from DIN EN 61512 ed. 2. The same state model is equally also specified in IEC 61512.

Since the method is used to define a service with its properties, it is appropriate if an opportunity is also provided for the operator to name the service of the process module, preferably at the beginning of the method. Otherwise, the operator would need to prescribe a name, which possibly hampers later fast detection of the content of the service.

The method can be extended to the effect that, at least for some of the states, the operator is provided with an option to define a parameter and an appropriate input for defining the parameter is received. Such parameters can be assigned a value by units outside the respective process module during the execution of the process in the process section. The value of the parameter can also be assignable by an operator (responsible person present in the factory) during the execution of the process in the process section. By way of example, the parameter can relate to an operating temperature of a component or of the material to be processed in a component. The service is then performable in or for an entire temperature range, and a current temperature is input or prescribed whenever said service is performed.

In this case, it is advantageous if the first and possibly also additionally or alternatively the second data indicate associations between values for the defined parameters and (other) values for the defined parameters. Thereby, the physical and chemical cause-effect relationships being describable by the parameter are considered. The associations can also involve only the parameter being indicated as cause, but a second signal varying with the parameter as effect (or even a first signal in the case of more complex relationships). By this, the physical and chemical cause-effect relationships being able to call for different consequences on the actuator side (possibly also for the sensors) when there are different values for the parameter are considered.

In one preferred embodiment of the method, there is provision for the information present in computer code to be provided in a form such that it is compilable by two different editors into two different codes executable by a control device, in particular programmable logic controller codes, PLC codes. In this way, it is possible to prescribe the services independently of the manufacturer of both the process module and the process management level used later and at once to derive a control code from the information provided by the method.

In one preferred embodiment of the method, there is provision for the information present in computer code to be used to generate a visual, in particular graphical, representation of the service of the process module. Such a representation makes it easier for the operator who is designing the service and for later users of the service (for example when designing the entire process section, what is known as orchestration) to grasp the functions of the service.

The further (that is to say second) method according to the invention for the computer-aided provision of information, available in the form of computer code, pertaining to a process module that is couplable to other process modules and is thus usable in an automated process section for implementing a technical, in particular chemical or pharmaceutical, process, and in this case at least two different services are performable, comprises the steps of:
performing the first method described above a first time,
performing this first method at least one further time,
combining the second data obtained each time the method as claimed in one of the preceding claims is performed to form a data aggregate.

The information provided by this second method thus comprises the information pertaining to at least two services (if the operator makes corresponding inputs), ideally pertaining to all desired services for the process module. This information can then be part of the MTP—that is to say incorporated into an MTP later—or identical to an MTP as a whole—that is to say itself provided in a suitable format. A process of designing the services is therefore used to at once create the necessary code for later use thereof.

The computer program product according to the invention for the computer-aided provision of information, available in the form of computer code, pertaining to a service of a process module that is couplable to other process modules and is thus usable in an automated process section for implementing a technical, in particular chemical or pharmaceutical, process by performing a service comprises a data carrier on which a computer program code is stored, wherein the computer program code, when loaded and called on a computer, causes the computer to carry out the first method described above in at least one of its embodiments or, in another variant of the computer program product, the second method described above. The method is therefore able to be carried out easily and quickly.

The data processing apparatus according to the invention for providing information, available in the form of computer code, pertaining to a service of a process module that is couplable to other process modules and is thus usable in an automated process section for implementing a technical, in particular chemical or pharmaceutical, process by performing a service has a human-machine interface, and it further has:
means for providing a selection option for states of the service of the process module from a prescribed state diagram having at least two states to an operator via the human-machine interface,
means for receiving an input from the operator via the human-machine interface for defining at least one state from the prescribed state diagram that the service is supposed to be able to adopt for the process module,
means for storing a list of units of the process module that deliver first signals and/or receive second signals,
means that, for each state that the service can adopt for the process module, use the human-machine interface to provide the option of inputting and receiving applicable inputs for providing first data, said first data indicating an association between possible first and second signals of the units from the list for a plurality of the units and in particular for all units as cause and possible first and second signals of the units from the list for a plurality of the units and in particular for all units as effect,
means that use the first data to determine second data, the latter indicating an association between possible first and second signals of the units from the list for a plurality of the units and in particular for all units as cause in an initial state of the service of the process module from all states that the service is supposed to be able to adopt and possible first and second signals of the units from the list for a plurality of the units and in particular for all units as effect in a final state of the service from all states that the process module is supposed to be able to adopt.

The advantages cited above in relation to the methods apply according to the data processing apparatus, and preferred embodiments are derivable accordingly.

All aforementioned means of the data processing apparatus can be provided in the form of processors or other data processing subunits of the data processing apparatus, such data processing subunits in one embodiment being able to take the function of multiple instances of said means at the same time. At least some of the means may be able to access memory devices, selected from memory devices of any type, or to comprise such memory devices.

The means can further encompass a specific program code being present and running on a unit, or they can comprise an applicable software block itself. Alternatively, some of the means can be provided as dedicated electrical circuits.

Preferably, there is provision for the human-machine interface to have a screen. Preferably, an input device is provided at the same time, for example a computer mouse. It can alternatively or additionally be provided by a suitable design of the screen, for example touchpads on the screen.

More preferably, there is provision for the data processing apparatus to have a memory for storing the provided first data and/or the provided second data (preferably all of the information available in the form of computer code).

Preferred embodiments of the invention are described in more detail below with reference to the drawing in which:

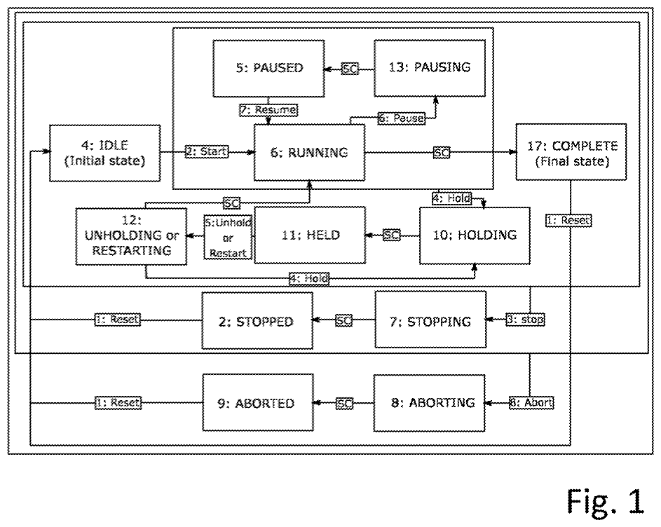

FIG. 1 shows a depiction (as a diagram) of a state model preferably used for the invention,

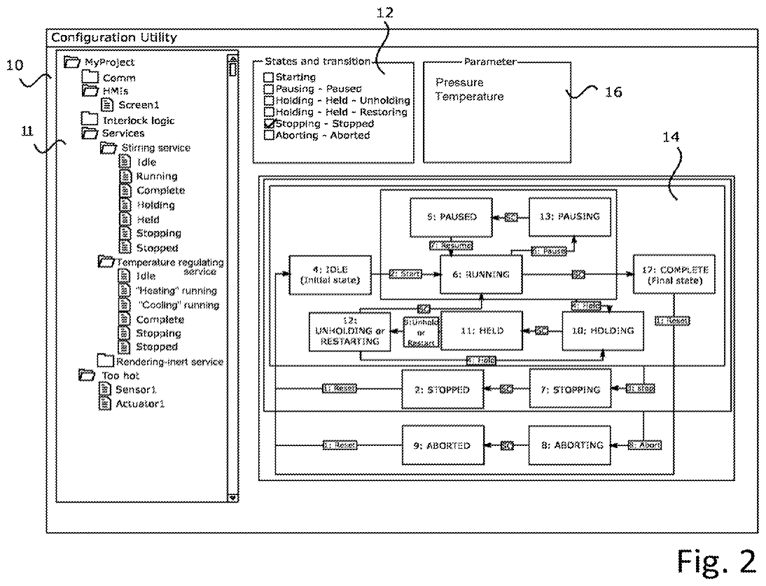

FIG. 2 shows a screen view during execution of a computer program for putting the method according to the invention into effect,

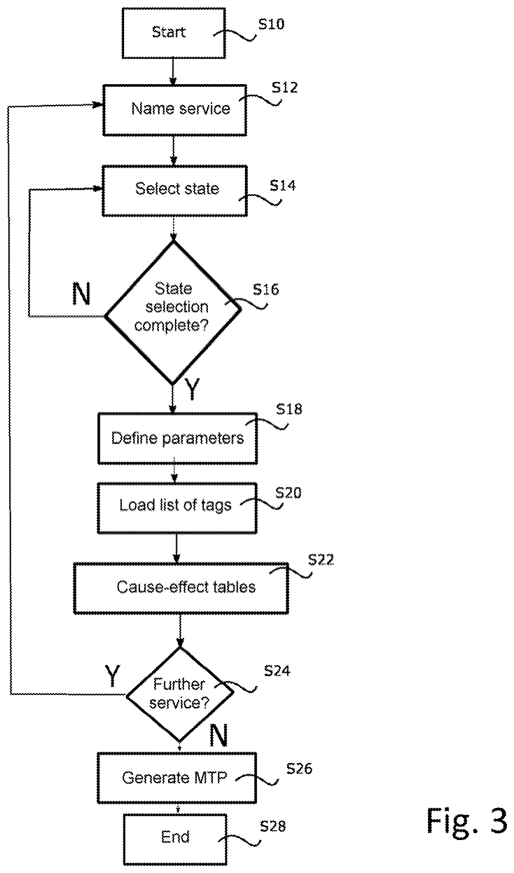

FIG. 3 shows a flowchart for a preferred embodiment of the method according to the invention,

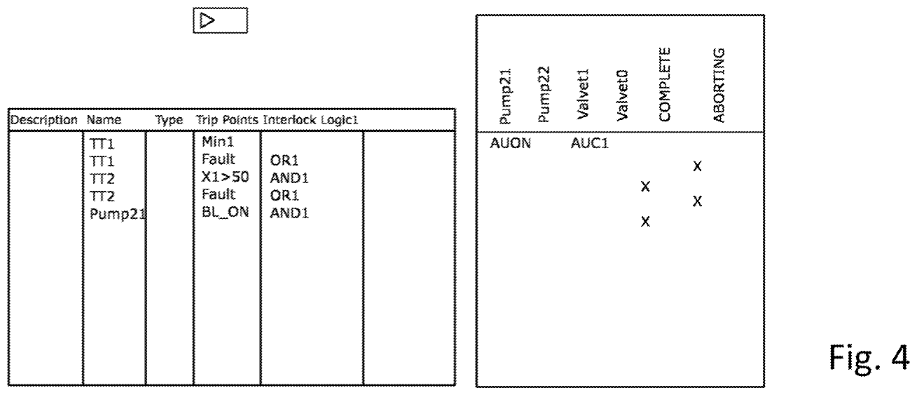

FIG. 4 shows a simplified depiction of a table to explain the assigning step in the preferred embodiment of the method according to the invention.

A process module, which is not shown in the figures, can be interconnected with other process modules to form a process section in which a chemical or pharmaceutical process is performable, each process module performing a specific function from a multiplicity of possible functions in a specific process. Such process-engineering functions are also referred to as services, or are “encapsulated” in such services. The computer program presented below has the task of defining such services with the aid of a (personal) computer. At the same time, information pertaining to the service is supposed to be provided that can be taken as a basis for allowing a superordinate control unit in the process (process management level) to actuate the process module. Preferably, this information is then present in the code IEC 61131-3. A complete data package for a process module is referred to as a “module type package” MTP.

The computer program defines every service on the basis of the same state model, which is depicted as a state diagram in FIG. 1.

This is the state model according to DIN EN 61512 ed. 2 or IEC 61512. The state model first contains the states “Idle”, “Running, “Aborting” and “Aborted”, which are necessarily present for any service. These are the initial state, the state of performing the process-engineering function and an aborting loop which is taken in the event of unscheduled aborting of the service. The loops for pausing the service (with “Pausing” and “Paused”), for holding the service (with “Holding”, “Held” and “Unholding” or “Restarting”) and for stopping (with “Stopping” and “Stopped”) the service are freely selectable, that is to say can be implemented or omitted by the model constructor as required. In the case of self-completing services, the state “Complete” is included. Continuous services, on the other hand, never achieve a set aim, but rather run continuously with alterable parameters. It is therefore advisable to implement the Stop loop in such services. In the case of process-engineering functions in which unscheduled and scheduled stopping do not differ from one another, implementation of the Aborting loop suffices.

The present computer program furthermore provides the option of selecting the further loops such as holding or pausing as well if the service is or is supposed to be complex. These loops are selectable only as a whole, with the transient states (ending in “ing”) that automatically change to the subsequent state via the state transition “Self-Complete” (see “SC” in FIG. 1).

The method is described in one embodiment below with reference to the applicable screen representation as shown in FIG. 2 and also at the same time with reference to the flowchart from FIG. 3.

The method begins in the embodiment with step S10, in which the program is started, that is to say typically a startup takes place. A mask, which is not shown, allows the input of alphanumeric characters in step S12 for the purpose of naming a service that is subsequently to be defined. A screen representation as shown in FIG. 3 is subsequently provided for steps S14 to S18. The frame of the screen representation, denoted as a whole by 10, first comprises an area (or subwindow) 11 having a folder for filing and specifying the individual services and also the associated states. Another area or subwindow 12 allows the selection of individual states and state groups in step S14 by checking them, the states “Idle”, “Running, “Aborting” and “Aborted” being present as an absolute prerequisite. The state diagram from FIG. 1 is displayed to the user in the window 14. Step S16 returns to step S14 if the state selection is not complete.

A subwindow 16 allows the user to define parameters in step S18 that are supposed to be important as an input variable or as a manipulated variable in the process. FIG. 2 shows the definition of the physical variables pressure and temperature as parameters in exemplary fashion.

In step S20, a list of what are known as “tags” is loaded, i.e. from a memory of the computer itself or from outside the memory. A “tag” is any component of the process module that provides input signals (typically sensors do this) and/or that reacts to output signals (such as typically actuators).

In step S22, tables in the style of those shown in FIG. 4 are then defined. As such, for example, it is specified that capture of the signal “Min1” by a sensor named “TT1” is supposed to result in the signal AUON being sent to a pump “Pump21” and the signal AUC1 being sent to a valve “Valvet1”. The column “Interlock Logic 1” logically combines multiple input signals. The statement “AND1” combines the two signals from a sensor “TT2” and from “Pump21”: if “TT2” has the signal “X1>1” and at the same time (AND function) “Pump21” has the signal “BL-ON”, then there is a transition to the state “Complete”. The latter contains what is known as a transition condition.

The tables are also referred to as “Extended Cause & Effect” tables and can be configured as described in EP 2 899 630 A1.

In the embodiment of the method, the tables are defined for all of the states; they can be understood as first data. In the subsequent step, the selected states and the associated tables can then be used to indicate a complete cause-effect relationship between the input signals for the whole process module (in the case of the defined service) and the output signals themselves, for example again in the form of a table. These are then second data. These second data alone can already be the aim of the method as information available in the form of computer code, but further information could also be added. As such, a visual, in particular graphical, representation of the service of the process module (graph) can be generated in order to better illustrate the mode of action to the informed observer.

In step S24, the user is asked by means of a screen representation or the like whether he wishes to define a further service. If so, the method returns to step S12. If all services are defined, there is transition to step S26.

The information obtained is preferably provided as IEC 61131-3 code and more preferably also comprises statements pertaining to the communication behavior of the process module or to the usable communication protocol. As such, there is the overall possibility of using step S26 to generate the MTP, which is needed later for actuating the process module.

The MTP concludes the method, see step S28 for the end.

1. A method for the computer-aided provision of information, the information available in the form of computer code, the information pertaining to a service of a process module that is couplable to other process modules and is thus usable in an automated process section for implementing a technical, in particular chemical or pharmaceutical, process by performing a service,
wherein the method comprises:
providing a selection option for states of the service of the process module from a prescribed state diagram having at least two states to an operator,
receiving an input from the operator for defining at least one state from the prescribed state diagram that the service is supposed to be able to adopt for the process module,
providing a list of units of the process module that deliver first signals and/or receive second signals,
for each state that the service can adopt for the process module, allowing and receiving inputs for providing first data, the latter indicating an association between possible first and second signals of the units from the list for a plurality of the units and in particular for all units as cause and possible first and second signals of the units from the list for a plurality of the units and in particular for all units as effect,
using the first data to determine second data, the latter indicating an association between possible first and second signals of the units from the list for a plurality of the units and in particular for all units as cause in an initial state of the service of the process module from all states that the service is supposed to be able to adopt and possible first and second signals of the units from the list for a plurality of the units and in particular for all units as effect in a final state of the service from all states that the process module is supposed to be able to adopt.

2. The method as claimed in claim 1, wherein some of the states from the prescribed state diagram are an absolute prerequisite for each process module and the selection option relates only to at least one further state or at least one state group.

3. The method as claimed in claim 2, wherein the state diagram corresponds to the state model from DIN EN 61512 ed. 2 or IEC 61512.

4. The method as claimed in claim 3, which further comprises an option for the operator to name the service of the process module.

5. The method as claimed in claim 1, which further comprises, at least for some of the states, an option to define a parameter and an appropriate input for defining the parameter is received.

6. The method as claimed in claim 5, wherein the first and/or the second data also indicate associations between values for the defined parameters and first and second signals or further values for the defined parameters.

7. The method as claimed in claim 1, in which the information present in computer code is provided in a form such that it is compilable by two different editors into two different codes executable by a control device, in particular programmable logic controller codes, PLC codes.

8. The method as claimed in claim 1, in which the information present in computer code is used to generate a visual, in particular graphical, representation of the service of the process module.

9. A method for the computer-aided provision of information, available in the form of a computer code, pertaining to a process module that is couplable to other process modules and is thus usable in an automated process section for implementing a technical, in particular chemical or pharmaceutical, process, and this involves at least two different services being performable,
wherein the method comprises the steps of:
performing the method as claimed in claim 1 a first time,
performing the method as claimed in claim 1 at least one further time,
combining the second data obtained each time the method as claimed in claim 1 is performed to form a data aggregate.

10. A computer program product for the computer-aided provision of information, available in the form of computer code, pertaining to a service of a process module that is couplable to other process modules and is thus usable in an automated process section for implementing a technical, in particular chemical or pharmaceutical, process by performing a service, wherein the computer program product comprises a data carrier on which a computer program code is stored, wherein the computer program code, when loaded and called on a computer, causes the computer to execute the code to implement a technical process by performing a service, comprising:
provide a selection option for states of the service of the process module from a prescribed state diagram having at least two states to an operator,
receive an input from the operator for defining at least one state from the prescribed state diagram that the service is supposed to be able to adopt for the process module,
provide a list of units of the process module that deliver first signals and/or receive second signals,
wherein for each state that the service can adopt for the process module, allowing and receiving inputs for providing first data, the latter indicating an association between possible first and second signals of the units from the list for a plurality of the units and in particular for all units as cause and possible first and second signals of the units from the list for a plurality of the units and in particular for all units as effect, and
use the first data to determine second data, the latter indicating an association between possible first and second signals of the units from the list for a plurality of the units and in particular for all units as cause in an initial state of the service of the process module from all states that the service is supposed to be able to adopt and possible first and second signals of the units from the list for a plurality of the units and in particular for all units as effect in a final state of the service from all states that the process module is supposed to be able to adopt.

11. A data processing apparatus for providing information, available in the form of computer code, pertaining to a service of a process module that is couplable to other process modules and is thus usable in an automated process section for implementing a technical, in particular chemical or pharmaceutical, process by performing a service,
wherein the data processing apparatus comprises:
a human-machine interface,
means for providing a selection option for states of the service of the process module from a prescribed state diagram having at least two states to an operator via the human-machine interface,
means for receiving an input from the operator via the human-machine interface for defining at least one state from the prescribed state diagram that the service is supposed to be able to adopt for the process module,
means for storing a list of units of the process module that deliver first signals and/or receive second signals,
means that, for each state that the service can adopt for the process module, use the human-machine interface to provide the option of inputting and receiving applicable inputs for providing first data, said first data indicating an association between possible first and second signals of the units from the list for a plurality of the units and in particular for all units as cause and possible first and second signals of the units from the list for a plurality of the units and in particular for all units as effect,
means that use the first data to determine second data, the latter indicating an association between possible first and second signals of the units from the list for a plurality of the units and in particular for all units as cause in an initial state of the service of the process module from all states that the service is supposed to be able to adopt and possible first and second signals of the units from the list for a plurality of the units and in particular for all units as effect in a final state of the service from all states that the process module is supposed to be able to adopt.

12. The data processing apparatus as claimed in claim 11, wherein the human-machine interface has a screen and an input device, preferably comprising a computer mouse and/or touchpads on the screen.

13. The data processing apparatus as claimed in claim 11, further having a memory for storing the provided first data and/or the provided second data.

14. The method as claimed in claim 1, which further comprises an option for the operator to name the service of the process module.

15. The method as claimed in claim 4, which further comprises, at least for some of the states, an option to define a parameter and an appropriate input for defining the parameter is received.

16. The method as claimed in claim 15, wherein the first and/or the second data also indicate associations between values for the defined parameters and first and second signals or further values for the defined parameters.

17. The method as claimed in claim 16, in which the information present in computer code is provided in a form such that it is compilable by two different editors into two different codes executable by a control device, in particular programmable logic controller codes, PLC codes.

18. The method as claimed in claim 17, in which the information present in computer code is used to generate a visual, in particular graphical, representation of the service of the process module.

19. The data processing apparatus as claimed in claim 12, further comprising a memory for storing the provided first data and/or the provided second data.

20. The method as claimed in claim 2, which further comprises an option for the operator to name the service of the process module.
